(19) United States
(12) Patent Application Publication
(10) Pub. No.: US 2024/0051032 A1
(43) Pub. Date: Feb. 15, 2024

(54) ROTARY-HEAD MACHINING UNIT

(71) Applicant: ESCO S.A., Les Geneveys-sur-Coffrane (CH)

(72) Inventors: Pierre-Louis PIGUET, Les Geneveys-sur-Coffrane (CH); Antonio ESPOSITO, Les Geneveys-sur-Coffrane (CH)

(73) Assignee: ESCO S.A., Les Geneveys-sur-Coffrane (CH)

(21) Appl. No.: 18/257,707

(22) PCT Filed: Dec. 13, 2021
(86) PCT No.: PCT/CH2021/000004

§ 371 Date: Jun. 15, 2023

(30) Foreign Application Priority Data
Dec. 21, 2020 (CH) 01633/2020

(51) Int. Cl. B23B 3/22

(52) U.S. Cl. CPC B23B 3/22

(57) ABSTRACT

A machining unit having a rotary head that bears pivoting tools for machining a non-rotating part centered on a rotational axis of the head. The supports for the pivoting tools are mounted in the head to pivot about respective axes that are parallel to the rotational axis. Each support has a transversely arranged control lever. A control bushing is mounted coaxially on the machining unit and is arranged to slide axially and adopt a first, advanced position or a second, retracted position. At one end of the control bushing bearing is arranged an ellipsoidal control surface so as to cooperate with helical directing surfaces that are connected to the tools in order to execute a plunging movement of the tools. There is provided a phase-offset device, which is arranged to move the control bushing into two, three or four different predetermined angular positions around its axis.

### TECHNICAL SCOPE

This invention relates to a rotary head machining unit that carries at least two pivoting tools to machine a non-rotary part centered on the rotational axis of the rotary head, including a frame on which a rotor is mounted, carried by two external bearings, said rotor having an axial channel and, coupled to rotational drive means, axial guiding means for said non-rotary part, these means being carried by bearings in the rotor and by the fixed support, means for holding and moving said non-rotary part axially, at least two tool holders mounted in said rotary head in order to pivot about respective axes parallel to the rotational axis, each holder comprising a control lever arranged transversally, pivoting control means cooperating with said lever and comprising a control element that is movable in axial translation in the rotor and coupled to a translation control device, and pairs of pusher elements arranged respectively on each control lever and on the corresponding control element, each pair of pusher elements comprising a guiding surface and a pushing surface resting against the guiding surface in a position that varies according to the translation of said control element, said guiding surface being located on the tool holder and the corresponding pushing surface being located on the control element, and every guiding surface corresponding to a pivoting tool holder having the shape of a helix portion whose axis coincides with the pivoting axis of said holder.

### PRIOR ART

The machining head of this type described in European patent no. EP 0 869 858 comprises a tool holder spindle equipped with two coupled tools, the pair of tools being controlled by a numerical axis. In this same invention, the feed of the part to be machined is ensured by two profiled disks fitting tightly around the part to be machined, one being driven by the axis motor and the other being carried by a shaft in charge of clamping the part to be machined.

In the prior art systems, the part to be machined is clamped by a collet in the feed system. If the diameter of the part to be machined becomes smaller than about 1 to 1.5 mm, any resistance due to machining can lead to the buckling of the part to be machined between the feed collet and the guiding system called guide bush, since the minimum distance between these two elements must correspond at least to the length of the part to be machined. The rotary disk feed allows a short and fixed distance between the feed system and the guide, which enables machining parts with a diameter of a few tenths of a millimeter.

Machining small dimension parts also requires considering the torsion induced by the cutting effort: the larger the distance between the feed system, which also holds the part in rotation, and the tool, the lower the torsional rigidity, which can be detrimental to machining. Finally, the longer the guiding system, the more expensive its production.

These considerations led to the current rotary machining heads, which use relatively short guides (about 100 mm), but whose number of tools is limited to two.

The solutions found until now to equip such heads with more than two tools all require a long construction, which makes them unusable in the present case.

### DESCRIPTION OF THE INVENTION

This invention offers a solution for this problem, allowing realizing, in the same space than the current machining heads, heads able to carry up to four tools selectable during the machining cycle, without needing to stop the rotation.

This goal is achieved by the machining unit according to the invention, characterized in that it comprises a control bush mounted coaxially on said spindle, this bush being arranged to slide axially and to be in a first advanced position, in a second retracted position, this bush carrying at one of its ends a control surface with an ellipsoidal shape arranged to cooperate with the helical guiding surfaces and to make the tools plunge, means for moving said control bush axially and a phase shift device arranged to bring said control bush in three or four predetermined angular positions about its axis.

According to a preferred embodiment, the means for moving the control bush comprise two rods driven by a linear actuator mounted in a set back manner in relation to the frame carrying the machining head.

Preferably, the two rods act on a box mounted on the control bush by means of two preloaded angular contact ball bearings

According to a particularly advantageous embodiment, the phase shift system is realized electronically. It consists of two separate drive motors, one for the rotor and the other for the control bush. Each motor is equipped with a system to measure its angular position. A specific functionality of the numerical control allows controlling both motors in order to ensure a perfectly synchronous rotation, but it also allows commanding an angular phase shift of one with respect to the other during the rotation. Choosing this solution allows dispensing totally with a complex and expensive mechanical system and greatly simplifies the construction. It is the result of an in-depth review of the technical possibilities as well as of a foresight analysis of the costs of the different versions.

### BRIEF DESCRIPTION OF THE DRAWINGS

The present invention and its main advantages will be better revealed in the description of the different embodiments, in reference to the drawings in appendix, in which:

FIG. 1 is an axial cross-sectional view of the machining unit according to the invention, showing the various bearings and the internal construction of the tool holder axes.

FIG. 2A illustrates the axial displacement means of the control bush.

FIG. 2B represents a front view of a version with three tool holders arranged at 120 degrees.

FIG. 3A illustrates the construction of a tool holder axis among the three identical ones.

FIGS. 3B and 3C represent partial views of the control bush sliding on the rotor, showing the elements taking part in the longitudinal guidance of the bush on the rotor.

FIG. 4A illustrates the control bush in rear position.

FIG. 4B shows its effect on the referenced tool holder, that is to say a retracted position.

FIG. 4C shows, in a cross-sectional plane identical to that of FIG. 4A, the control bush in advanced position.

FIG. 4D shows its effect on the referenced tool holder, that is to say a maximum plunging position in the part to be machined.

FIG. 5 is a transversal cross-sectional view of the three-tool machining unit according to the invention showing the three tool holder axes brought back in retracted position by the return springs when the bush is completely retracted.

FIGS. 6A and 6B illustrate the correspondence between the position of the first tool holder, at the maximum plunging depth, the angular position of the ellipsoidal contact surface on the control bush, and the pivoting of the lever integral with the tool holder axis.

FIGS. 7A, 7B and 8A, 8B illustrate the same situation respectively for the second and third tool holder axes, and

FIG. 9 illustrates the construction of the electronic phase shift system.

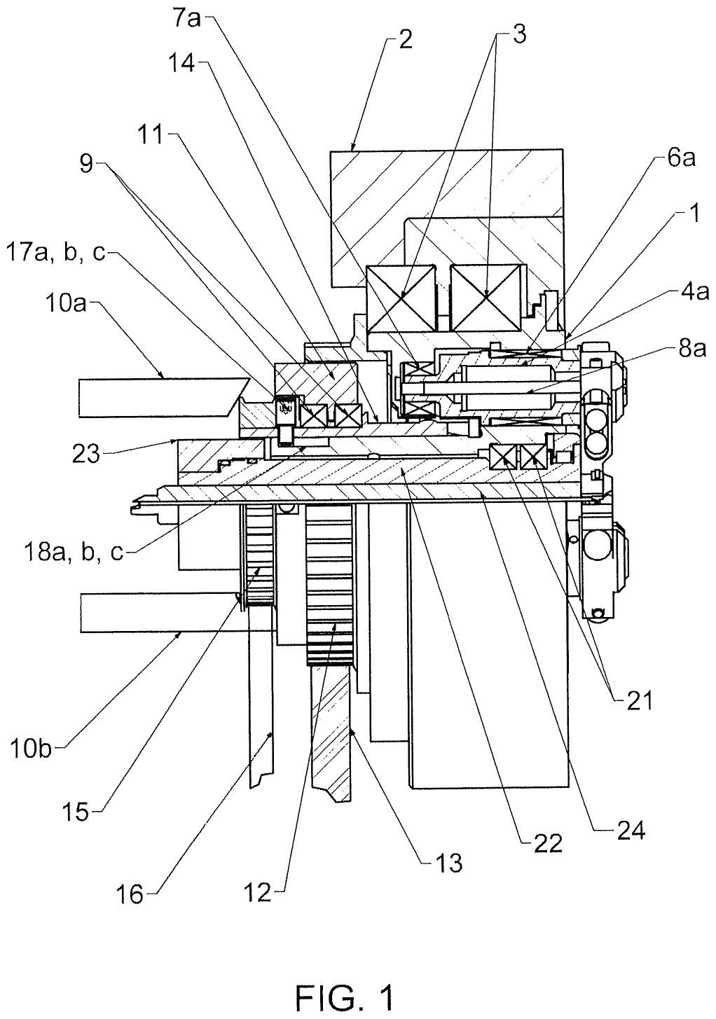

### BEST WAYS OF REALIZING THE INVENTION

Referring to the figures, the three-tool spindle is made of a rotor 1 carried by a pair of bearings 3, the whole being mounted in a housing 2. The rotational drive is ensured by timing belt 13 meshing with toothed pulley 12.

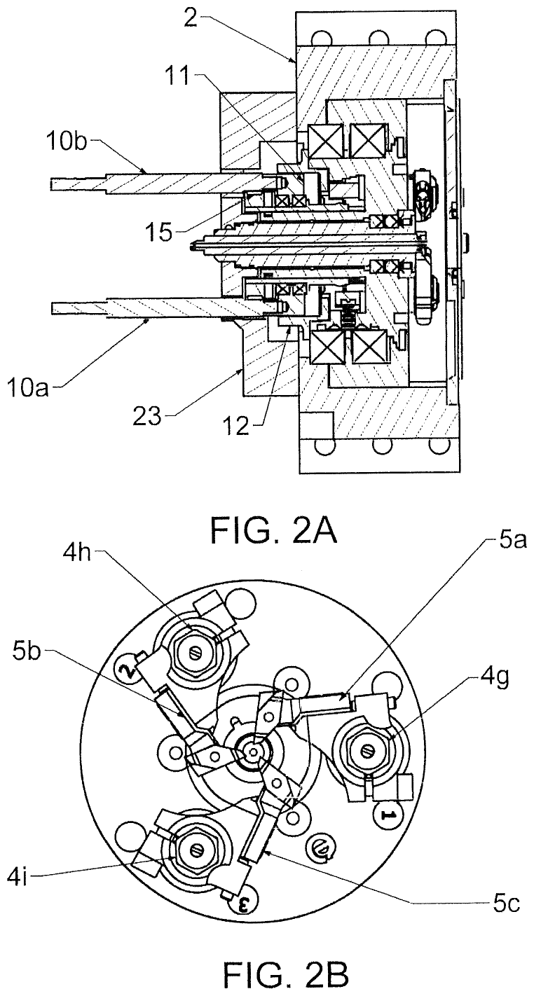

A non-rotary tube 22 is located in the center of the spindle and is supported at one end in fixed support 23, which also serves as a guide for control rods 10a, 10b of FIG. 2A, and supported at the other end by a pair of precision bearings 21 housed in rotor 1. The guide bushes 24, which are accurately adjusted for the diameter of the part to be machined, are inserted in this tube.

Three identical tool holder axes 4a, 4b, 4c are mounted in this rotor. A hexagon 4g, 4h, 4i located at each end outside of the spindle allows mounting various cutting tool carriers 5a, 5b and 5c. Every lever-shaped rear section 4j, 4k, 41 carries helix portion 4d, 4e, 4f that will be in contact with the control bush.

Every axis is supported radially by two needle bearings 6a, 6b, 6c and 7a, 7b, 7c; the axial play is adjusted with elements 8a, 8b, 8c.

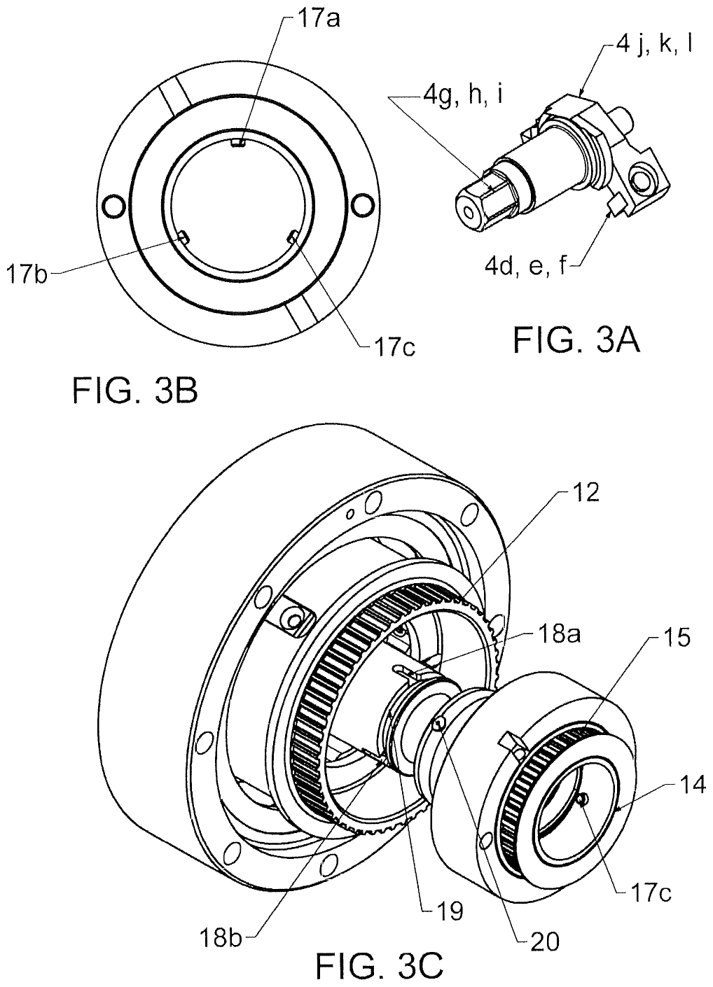

The axial movement of control rods 10a, 10b is transmitted to spool 11. The pair of bearings 9 connects non-rotary spool 11 and rotary control bush 14, which slides on the shank of rotor 1 and turns with it. This bush has its own rotational drive by means of belt 16 and pulley 15. Three pins 17a, 17b, 17c are integral with pulley 15 and bush 14 and located at 120° from each other (FIGS. 3B and 3C). When control bush 14 is in retracted axial position, they reach into radial groove 19 located in rotor 1; in this position, the angular displacement of bush 14 with respect to rotor 1 is possible, since pins 17a, 17b, 17c are free in groove 19.

Three longitudinal grooves 18a, 18b, 18c, machined at 120°, are also provided in rotor 1. For three angular positions of bush 14, pins 17a, 17b, 17c will be located in front of these grooves; it is then possible to move bush 14 forward by means of control rods 10a and 10b, and thus make one of the tools plunge. In fact, when bush 14 advances, contact point 20 will enter in contact with helix portion 4d or 4e or 4f of selected tool holder 1, 2, 3, and thus make axis 4a, 4b, 4c pivot, making the selected tool plunge into the part to be machined.

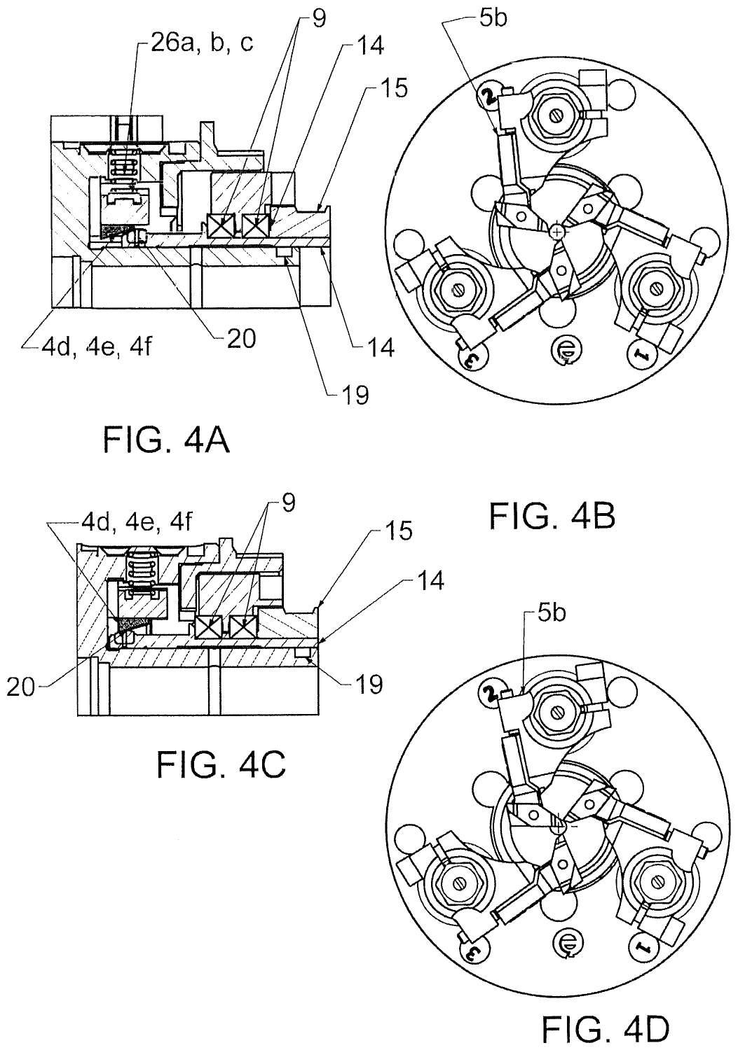

FIGS. 4A to 4D illustrate this functionality for tool holder 2. FIG. 4A shows a cross-section of control bush 14 in retracted position, which corresponds to a retracted position of the tip of tool 2 visible on FIG. 4B. On FIG. 4C, bush 14 is completely advanced, and on FIG. 4D, this position of control bush 14 drove the tip of tool 2 beyond the axis of the spindle, and thus of the part to be machined.

In the chosen construction, on every tool holder axis 4a, 4b, 4c, a spring 26a, 26b, 26c maintains the contact of helix portion 4d, 4e, 4f with point 20 of the bush, even if the bush retracts.

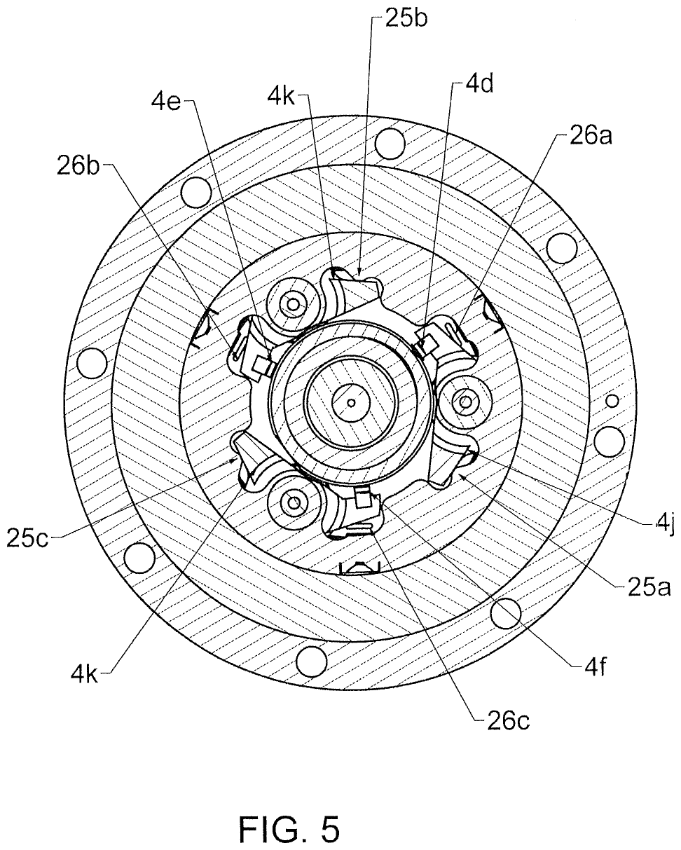

However, in the maximum retracted position of bush 14, a boss 25a, 25b, 25c on rotor 1 serves as a stop for every tool holder axis 4a, 4b, 4c according to FIG. 5. It therefore limits the angular travel of the axes when bush 14 reaches its maximum retraction. In this axial position of bush 14, there is no longer any contact between helix portions 4d, 4e, 4f and contact point 20 of bush 14. This position also brings pins 17a, 17b, 17c in a position corresponding to groove 19. These two conditions make possible the free rotation of bush 14 with respect to rotor 1, without risk of damaging contact point 20, nor helices 4d, 4e, 4f.

In summary, in retracted position, bush 14 can be turned freely with respect to rotor 1. After having positioned angularly bush 14 in such a way that the three pins 17a, 17b, 17c are in front of longitudinal grooves 18a, 18b, 18c, which corresponds to three possibilities all spaced by 120°, it is possible to advance bush 14 and therefore to make the selected tool plunge.

In fact, each of these three angular positions allows, moving bush 14 axially, to bring point 20 in contact with helix portion 4d or 4e or 4f of one of the three different tool holders. It thus makes possible the plunging of the chosen tool, so that tool selection is therefore performed.

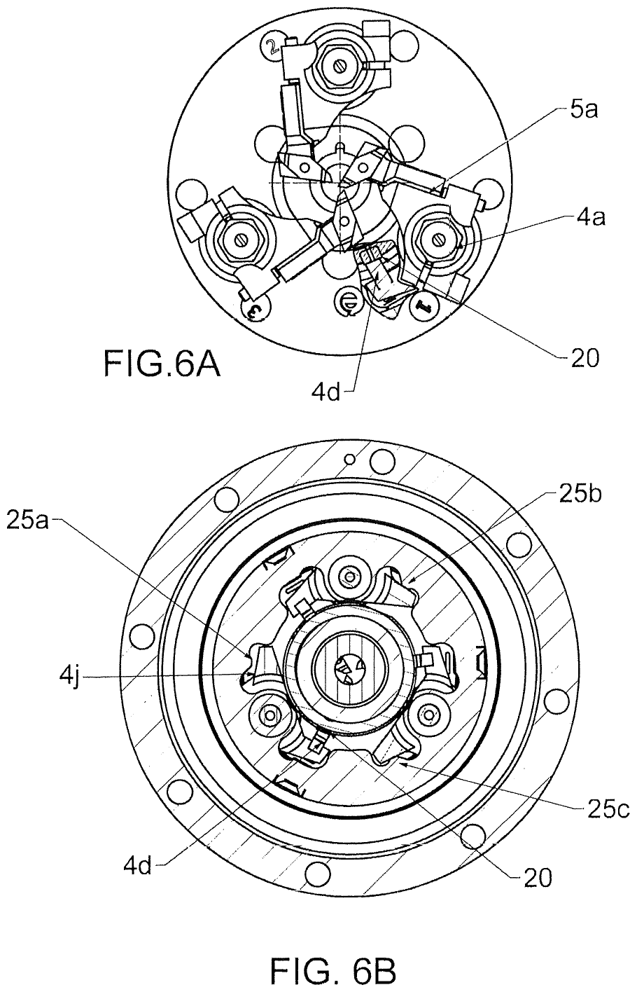

FIGS. 6A and 6B illustrate the case of the first tool holder axis, whose tool tip is completely plunged. To do so, contact point 20 has been brought in front of helix portion 4d of axis no. 1 and bush 14 has been pushed forward. FIG. 6B shows that lever 4j is lifted from stop 25a. On the other hand, it can be seen that the two other axes are resting on their respective stop 25b and 25c.

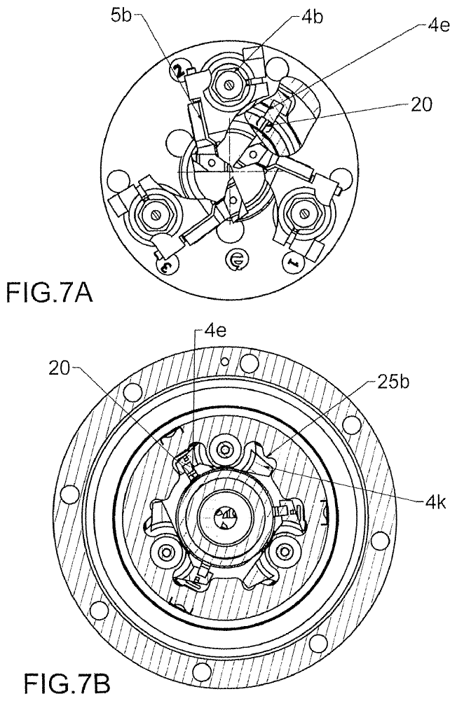

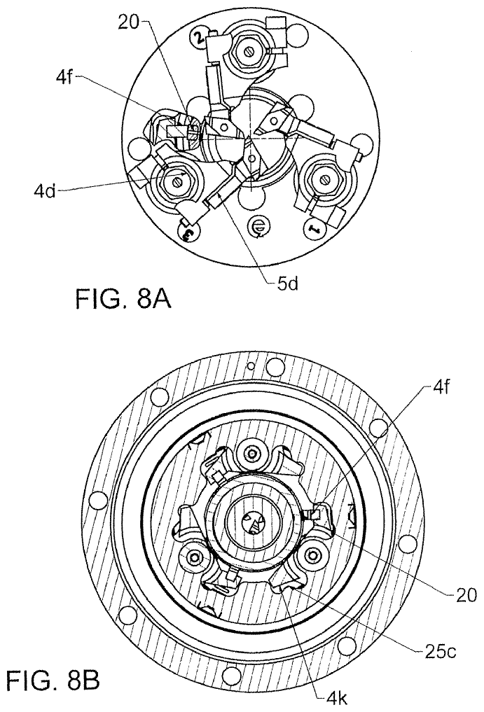

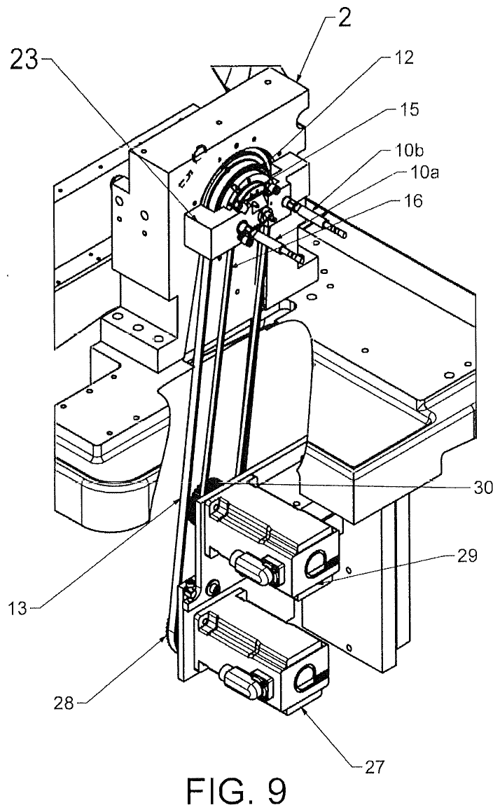

FIGS. 7A and 7B, respectively 8A and 8B, illustrate the cases of the second and third tool holder, with the tool tip in a position similar to that of FIG. 6A. FIGS. 7B and 8B clearly show the different angular positions of contact point in each case and the fact that only the controlled axis is lifted from its stop.

When the pins are engaged in grooves 18a, b, c, the phase shift is no longer possible, pins 17a, 17b, 17c then serve as a longitudinal guide.

In the electronic phase shift system, each of belts 13 and 16 is driven by a separate motor 27, respectively 29, equipped each with a toothed pulley 28, respectively 30. The motor/spindle transmission ratio must preferably be an integer; in a particular case, the chosen ratio is equal to 1. Each motor has an electronic encoder that measures its angular position and provides a reference index once per revolution. The electronic control system (CNC) allows driving both spindle elements in a perfectly synchronous way, motor 29 copying at any time its angular position from that of motor 27. It also includes commands that allow instructing motor 29 to shift its angular position by a defined value with respect of that of motor 27, and this while the spindle is working, that is to say while both motors are rotating.

This functionality thus makes possible choosing freely to work with one of the three tool holders 4a or 4b or 4c while the spindle is rotating.

It would readily allow realizing a spindle with two or four tool holders instead of three, since there is no limitation in the number of programmable positions.

The advantages provided by the machining unit according to the invention with respect to the system of the prior art are the following:

The decisive point is the specific arrangement of main bearings 3. It offers major advantages in terms of rigidity and load bearing capacity. It also allows having a specific greasing point for bearings 3, ensuring total control on the supplied lubricant quantity, and therefore on the temperature and operating conditions of the spindle.

It also allows considering an easy replacement of bearings 21 of guide bush support tube 22, which are the most exposed to cutting chips and machining forces.

It allows providing a facilitated and complete replacement of this central section receiving the guide bush. From this results the possibility to use different guide bush types on the same spindle; the system of the prior art, but also commercial, adjustable guide bushes, and guide bushes used on standard automatic lathes with rotating bar. It is also an opening towards any future evolution in the guiding systems for parts to be machined.

This arrangement finally allows supplying in a simple way cutting oil through the guide bush up to the tools without having to pass the obstacle created by the rotating tools passing in front of the jet.

The characteristics above can readily apply to the realization of a spindle with two tools controlled according to the prior art. Alone these represent a major technological leap.

But these modifications also make possible the realization of a spindle using a controlled angular shift system for the tools control bush with respect to the spindle, and this during the rotation. It is thus possible to consider realizing short spindles with two, three or even four tools, limit imposed by the use of a pivoting tool holders system.

The solution described is that of a three-tool system; the two-tool version with controlled angular shift offers no significant advantage with respect to the classic solution. The benefit is much more interesting with three tools, while still keeping an arrangement that is not too tight compared to the four-tool version.

There is more freedom for the shapes of the tool holders and more space for cutting chips evacuation.

1. A rotary head machining unit that carries at least two pivoting tools to machine a non-rotary part centered on a rotational axis of the rotary head, including a frame (2) on which a rotor (1) is mounted, carried by two external bearings (3), said rotor (1) having an axial channel and, coupled to rotational drive means (12 and 15), axial guiding means for said non-rotary part (22 and 24), the axial guiding means being carried by bearings (21) in said rotor (1) and by fixed support (23), means for holding and moving said non-rotary part axially, at least two tool holders (4a-4c) mounted in said rotary head in order to pivot about respective axes parallel to the rotational axis, each of the at least two tool holders comprising a control lever (4j-41) arranged transversally, pivoting control means cooperating with said control lever and comprising a control element (14) that is movable in axial translation in the rotor and coupled to a translation control device, and pairs of pusher elements arranged respectively on each of the control levers and on the corresponding control element, each of the pairs of pusher elements comprising a guiding surface (4d-4f) and a pushing surface (20) resting against the guiding surface in a position that varies according to the translation of said control element (14), said guiding surface (4d-4f) being located on the tool holder and the corresponding pushing surface (20) being located on said control element (14), and every guiding surface corresponding to a pivoting tool holder having the shape of a helix portion whose axis coincides with the pivoting axis of said tool holder, wherein said control element is a control bush (14) mounted coaxially on a spindle, said control bush (14) being arranged to slide axially and to be in a first advanced position, in a second retracted position, said control bush (14) carrying at one end thereof a control surface with an ellipsoidal shape (20) arranged to cooperate with said helical guiding surfaces (4d-4f) and to make the pivoting tools plunge, means for moving said control bush (14) axially and a phase shift device arranged to bring said control bush (14) in two, three or four predetermined angular positions about its axis.

2. The rotary head machining unit according to claim 1, wherein the phase shift system is made of two separate drive motors (27 and 29), one for driving said rotor (1) by means of a first pulley (28), a belt (13) and a second pulley (12), the other for driving said control bush (14) by means of a third pulley (30), another belt (16) and a fourth pulley (15), each of the drive motors being equipped with a system to measure its angular position.

3. The rotary head machining unit according to claim 2, further comprising a numerical control means that allow controlling both of the drive motors in order to ensure a perfectly synchronous rotation, but it also allows commanding any angular phase shift of one of the drive motors with respect to the other of the drive motors during the rotation.

4. A machining unit according to claim 1, further comprising means that allow a complete change of central section (22 and 21) receiving axial guiding means (24), thus allowing the easy replacement of said bearings (21) and possible adaptation of other guiding systems for the part to be machined, without having to modify the spindle itself.

5. The machining unit according to claim 1, wherein three tool holder axes (4a, 4b, 4c) are mounted in the rotor, all being identical, wherein a hexagon (4g, 4h, 4i) located on each end outside of the spindle allows mounting various cutting tool carriers (5a, 5b 5c).

6. The rotary head machining unit according to claim 1, wherein a lever-shaped rear section of each of the control levers (4j, 4k, 4l) carries a helix portion (4d, 4e, 4f) that will be in contact with said control bush (14).

7. The rotary head machining unit according to claim 1, wherein every axis is supported radially by two needle bearings (6a, 6b, 6c and 7a, 7b, 7c); the axial play being adjusted with elements (8a, 8b, 8c).

8. The rotary head machining unit according claim 1, wherein axial movement of control rods (10a, 10b) is transmitted to a non-rotary spool (11) and in that a pair of bearings (9) connects said non-rotary spool (11) and said rotary control bush (14), which slides on a shank of said rotor (1) and turns therewith.

9. The rotary head machining unit according to claim 8, wherein said rotary control bush (14) has a rotational drive by means of a belt (16) and a pulley (15) and in that three pins (17a, 17b, 17c) are integral with said pulley (15) and said control bush (14) and located at 120° from each other.

10. The rotary head machining unit according to claim 1, wherein the means for moving said control bush (14) comprise two rods (10a and 10b) driven by a linear actuator mounted in a set back manner in relation to the frame carrying the machining rotary head.

11. The rotary head machining unit according to claim 10, wherein said two rods act on a box (12) mounted on said control bush (14) by means of two preloaded angular contact ball bearings (9).
